(19) United States
(12) Patent Application Publication
(10) Pub. No.: US 2022/0405749 A1
(43) Pub. Date: Dec. 22, 2022

(54) ALLOCATION OF A DIGITAL ASSET USING BLOCKCHAIN TRANSACTIONS

(71) Applicant: nChain Holdings Limited, St. John's (AG)

(72) Inventors: Chloe TARTAN, London (GB); Craig Steven WRIGHT, London (GB)

(21) Appl. No.: 17/760,726

(22) PCT Filed: Aug. 18, 2020
(86) PCT No.: PCT/IB2020/057765

§ 371 Date: Mar. 15, 2022

(30) Foreign Application Priority Data
Sep. 17, 2019 (GB) 1913386.7

(51) Int. Cl. G06Q 20/38; G06Q 20/40; H04L 9/00

(52) U.S. Cl. CPC G06Q 20/3829; G06Q 20/401; H04L 9/50; G06Q 2220/00

(57) ABSTRACT

A computer-implemented method of generating a transaction associated with a blockchain, the transaction being for distributing amounts of an allocation of a digital asset, wherein the allocating party is associated with an allocating public key linked with the allocation, and wherein each recipient party is associated with a respective ownership public key. The method comprises obtaining a respective ownership public key of each of the one or more recipient parties. For each of the one or more recipient parties, a respective payment public key is generated based on (i) the ownership public key associated with that recipient user, and (ii) the allocating public key. The transaction comprises one or more output scripts, each output script configured to transfer a respective amount of the allocation to a respective payment address, the respective payment address being based on the respective payment public key.

### CROSS REFERENCE TO RELATED APPLICATIONS

This application is the U.S. National Stage of International Application No. PCT/IB2020/057765 filed on Aug. 18, 2020, which claims the benefit of United Kingdom Patent Application No. 1913386.7, filed on Sep. 17, 2019, the contents of which are incorporated herein by reference in their entireties.

### TECHNICAL FIELD

The present disclosure relates to methods of securely allocating or distributing amounts of a digital asset to one or more recipient parties using blockchain transactions. In particular, the methods ensure that only an intended recipient party can access their respective amount of the digital asset.

### BACKGROUND

A blockchain refers to a form of distributed data structure, wherein a duplicate copy of the blockchain is maintained at each of a plurality of nodes in a peer-to-peer (P2P) network. The blockchain comprises a chain of blocks of data, wherein each block comprises one or more transactions. Each transaction may point back to a preceding transaction in a sequence which may span one or more blocks. Transactions can be submitted to the network to be included in new blocks by a process known as “mining”, which involves each of a plurality of mining nodes competing to perform “proof-of-work”, i.e. solving a cryptographic puzzle based on a pool of the pending transactions waiting to be included in blocks.

Conventionally the transactions in the blockchain are used to convey a digital asset, i.e. data acting as a store of value. However, a blockchain can also be exploited in order to layer additional functionality on top of the blockchain. For instance, blockchain protocols may allow for storage of additional user data in an output of a transaction. Modern blockchains are increasing the maximum data capacity that can be stored within a single transaction, enabling more complex data to be incorporated. For instance this may be used to store an electronic document in the blockchain, or even audio or video data.

Each node in the network can have any one, two or all of three roles: forwarding, mining and storage. Forwarding nodes propagate transactions throughout the nodes of the network. Mining nodes perform the mining of transactions into blocks. Storage nodes each store their own copy of the mined blocks of the blockchain. In order to have a transaction recorded in the blockchain, a party sends the transaction to one of the nodes of the network to be propagated. Mining nodes which receive the transaction may race to mine the transaction into a new block. Each node is configured to respect the same node protocol, which will include one or more conditions for a transaction to be valid. Invalid transactions will not be propagated nor mined into blocks. Assuming the transaction is validated and thereby accepted onto the blockchain, the additional user data will thus remain stored at each of the nodes in the P2P network as an immutable public record.

Within a typical blockchain protocol, a party owns a unique private key which can be used to identify that party. However, due to the need to maintain privacy of the private key, the private key cannot be used directly to identify the party. Instead, a cryptographic signature scheme is used in which each private key is paired with a corresponding public key. The public key, which also uniquely identifies a party, can be shared with other parties and made publicly available.

### SUMMARY

According to one aspect disclosed herein, there is provided a computer-implemented method of generating at least one transaction associated with a blockchain, the at least one transaction being for distributing amounts of an allocation of a digital asset from an allocating party to one or more recipient parties, wherein the allocating party is associated with an allocating public key linked with the allocation, wherein each recipient party is associated with a respective ownership public key; and wherein the method comprises: obtaining a respective ownership public key of each of the one or more recipient parties; for each of the one or more recipient parties, generating a respective payment public key based on (i) the ownership public key associated with that recipient user, and (ii) the allocating public key; and generating the at least one transaction, wherein the at least one transaction comprises one or more output scripts, each output script configured to transfer a respective amount of the allocation to a respective payment address, the respective payment address being based on the respective payment public key.

The present disclosure recognizes a way of utilizing public-private key pairs in order to ensure that amounts of a digital asset are distributed to, and only accessible by, specific parties (i.e. intended recipients). In other words, the allocating party allocates payments to specific recipients and only those recipients can access those payments. The disclosure also ensures that multiple recipients can securely access their respective amounts of the digital asset simultaneously and transparently. An allocating party has access to an allocation of the digital asset and can generate a payment public key unique to each intended recipient. The payment public key is based on an ownership public key that is unique to a recipient. A public key may act as a blockchain address for transferring an amount (or share) of a digital asset using blockchain transactions. Alternatively, an address may be generated based on a public key, e.g. a pay-to-public key hash (P2PKH). Each public key is part of a public-private key pair. The private key from a public-private key pair is required in order to access the digital asset transferred to a blockchain payment address (e.g. the corresponding public key or P2PKH). Given that the payment public key for a recipient (e.g. Alice) is based on Alice's ownership public key, and only Alice has access to the corresponding ownership private key, only Alice can generate the required payment private key in order to access the funds transferred to the payment address.

By obtaining the ownership public key of each recipient, the allocating party can generate a set of corresponding payment public keys, each linked to a particular recipient. The allocating party can allocate amounts of the digital asset (e.g. tokens denoting ownership of a real-world asset) to the recipients' payment addresses.

According to another aspect disclosed herein, there is provided a computer-implemented method of accessing an amount of a digital asset, the amount of the digital asset being transferred from an allocating public key of an allocating party to a payment address of a recipient party using a transaction associated with a blockchain, wherein the recipient party is associated with an ownership public key; and wherein the method comprises: causing a first transaction comprising the ownership public key to be included in the blockchain; obtaining an allocating private key paired with the allocating public key; determining a payment address based on a payment public key, wherein the payment public key has been generated based on the ownership public key and the allocating public key; and determining, using the allocating private key, a payment private key paired with the payment public key.

In this method, the recipient (e.g. Alice) registers their unique ownership public key using a transaction of the blockchain, either directly or indirectly. For example, Alice may directly register her ownership public by including it within an output of a blockchain transaction. Alice may indirectly register her ownership public key by asking a third party to include her ownership public key within an output of a blockchain transaction. Once committed to the blockchain, the transaction acts as an immutable record linking Alice to her ownership public key. Furthermore, by storing the ownership public key on the blockchain, the allocating party can obtain it in order to generate a payment public key, and therefore a payment address, for Alice. Using knowledge of her ownership private key and the allocating party's private key, Alice is also able to determine the payment public key to which her share (amount) of the digital asset has been transferred. Alice can then access her share of the digital asset. Since no other party has access to Alice's private ownership key, they cannot access the digital asset that has been transferred to Alice's payment address.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain;

FIG. 2 schematically illustrates some examples of transactions which may be recorded in a blockchain;

FIG. 3 is a schematic block diagram of a system for allocating amounts of a digital asset to recipient parties;

FIG. 4 is a schematic representation of a blockchain transaction for allocating amounts of a digital asset to a plurality of recipients;

FIGS. 5a and 5b schematically illustrate examples blockchain transactions for registering a recipient party's ownership public key; and

FIG. 6 schematically illustrates another example blockchain transactions for registering a recipient party's ownership public key.

### DETAILED DESCRIPTION OF EMBODIMENTS

### Example System Overview

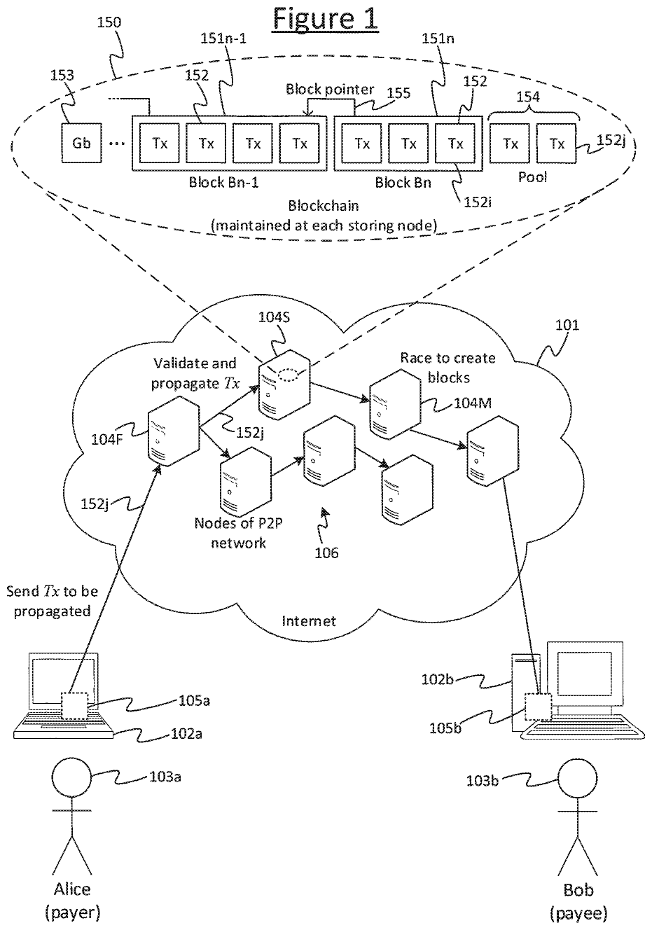

FIG. 1 shows an example system 100 for implementing a blockchain 150 generally. The system 100 comprises a packet-switched network 101, typically a wide-area internetwork such as the Internet. The packet-switched network 101 comprises a plurality of nodes 104 arranged to form a peer-to-peer (P2P) overlay network 106 within the packet-switched network 101. Each node 104 comprises computer equipment of a peers, with different ones of the nodes 104 belonging to different peers. Each node 104 comprises processing apparatus comprising one or more processors, e.g. one or more central processing units (CPUs), accelerator processors, application specific processors and/or field programmable gate arrays (FPGAs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of nodes in the P2P network 160. Each block 151 in the chain comprises one or more transactions 152, wherein a transaction in this context refers to a kind of data structure. The nature of the data structure will depend on the type of transaction protocol used as part of a transaction model or scheme. A given blockchain will typically use one particular transaction protocol throughout. In one common type of transaction protocol, the data structure of each transaction 152 comprises at least one input and at least one output. Each output specifies an amount representing a quantity of a digital asset belonging to a user 103 to whom the output is cryptographically locked (requiring a signature of that user in order to be unlocked and thereby redeemed or spent). Each input points back to the output of a preceding transaction 152, thereby linking the transactions.

At least some of the nodes 104 take on the role of forwarding nodes 104F which forward and thereby propagate transactions 152. At least some of the nodes 104 take on the role of miners 104M which mine blocks 151. At least some of the nodes 104 take on the role of storage nodes 104S (sometimes also called “full-copy” nodes), each of which stores a respective copy of the same blockchain 150 in their respective memory. Each miner node 104M also maintains a pool 154 of transactions 152 waiting to be mined into blocks 151. A given node 104 may be a forwarding node 104, miner 104M, storage node 104S or any combination of two or all of these.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the pool 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the signature of the user 103a to whom the output of the preceding transaction 152i is locked. In turn, the output of the present transaction 152j can be cryptographically locked to a new user 103b. The present transaction 152j can thus transfer the amount defined in the input of the preceding transaction 152i to the new user 103b as defined in the output of the present transaction 152j. In some cases a transaction 152 may have multiple outputs to split the input amount between multiple users (one of whom could be the original user 103a in order to give change). In some cases transaction can also have multiple inputs to gather together the amounts from multiple outputs of one or more preceding transactions, and redistribute to one or more outputs of the current transaction.

The above may be referred to as an “output-based” transaction protocol, sometimes also referred to as an unspent transaction output (UTXO) type protocol (where the outputs are referred to as UTXOs). A user's total balance is not defined in any one number stored in the blockchain, and instead the user needs a special “wallet” application 105 to collate the values of all the UTXOs of that user which are scattered throughout many different transactions 152 in the blockchain 151.

An alternative type of transaction protocol may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

With either type of transaction protocol, when a user 103 wishes to enact a new transaction 152j, then he/she sends the new transaction from his/her computer terminal 102 to one of the nodes 104 of the P2P network 106 (which nowadays are typically servers or data centres, but could in principle be other user terminals). This node 104 checks whether the transaction is valid according to a node protocol which is applied at each of the nodes 104. The details of the node protocol will correspond to the type of transaction protocol being used in the blockchain 150 in question, together forming the overall transaction model. The node protocol typically requires the node 104 to check that the cryptographic signature in the new transaction 152j matches the expected signature, which depends on the previous transaction 152i in an ordered sequence of transactions 152. In an output-based case, this may comprise checking that the cryptographic signature of the user included in the input of the new transaction 152j matches a condition defined in the output of the preceding transaction 152i which the new transaction spends, wherein this condition typically comprises at least checking that the cryptographic signature in the input of the new transaction 152j unlocks the output of the previous transaction 152i to which the input of the new transaction points. In some transaction protocols the condition may be at least partially defined by a custom script included in the input and/or output. Alternatively it could simply be a fixed by the node protocol alone, or it could be due to a combination of these. Either way, if the new transaction 152j is valid, the current node forwards it to one or more others of the nodes 104 in the P2P network 106. At least some of these nodes 104 also act as forwarding nodes 104F, applying the same test according to the same node protocol, and so forward the new transaction 152j on to one or more further nodes 104, and so forth. In this way the new transaction is propagated throughout the network of nodes 104.

In an output-based model, the definition of whether a given output (e.g. UTXO) is spent is whether it has yet been validly redeemed by the input of another, onward transaction 152j according to the node protocol. Another condition for a transaction to be valid is that the output of the preceding transition 152i which it attempts to spend or redeem has not already been spent/redeemed by another valid transaction. Again if not valid, the transaction 152j will not be propagated or recorded in the blockchain. This guards against double-spending whereby the spender tries to spend the output of the same transaction more than once. An account-based model on the other hand guards against double-spending by maintaining an account balance. Because again there is a defined order of transactions, the account balance has a single defined state at any one time.

In addition to validation, at least some of the nodes 104M also race to be the first to create blocks of transactions in a process known as mining, which is underpinned by “proof of work”. At a mining node 104M, new transactions are added to a pool of valid transactions that have not yet appeared in a block. The miners then race to assemble a new valid block 151 of transactions 152 from the pool of transactions 154 by attempting to solve a cryptographic puzzle. Typically this comprises searching for a “nonce” value such that when the nonce is concatenated with the pool of transactions 154 and hashed, then the output of the hash meets a predetermined condition. E.g. the predetermined condition may be that the output of the hash has a certain predefined number of leading zeros. A property of a hash function is that it has an unpredictable output with respect to its input. Therefore this search can only be performed by brute force, thus consuming a substantive amount of processing resource at each node 104M that is trying to solve the puzzle.

The first miner node 104M to solve the puzzle announces this to the network 106, providing the solution as proof which can then be easily checked by the other nodes 104 in the network (once given the solution to a hash it is straightforward to check that it causes the output of the hash to meet the condition). The pool of transactions 154 for which the winner solved the puzzle then becomes recorded as a new block 151 in the blockchain 150 by at least some of the nodes 104 acting as storage nodes 104S, based on having checked the winner's announced solution at each such node. A block pointer 155 is also assigned to the new block 151n pointing back to the previously created block 151n-1 in the chain. The proof-of-work helps reduce the risk of double spending since it takes a large amount of effort to create a new block 151, and as any block containing a double spend is likely to be rejected by other nodes 104, mining nodes 104M are incentivised not to allow double spends to be included in their blocks. Once created, the block 151 cannot be modified since it is recognized and maintained at each of the storing nodes 104S in the P2P network 106 according to the same protocol. The block pointer 155 also imposes a sequential order to the blocks 151. Since the transactions 152 are recorded in the ordered blocks at each storage node 104S in a P2P network 106, this therefore provides an immutable public ledger of the transactions.

Note that different miners 104M racing to solve the puzzle at any given time may be doing so based on different snapshots of the unmined transaction pool 154 at any given time, depending on when they started searching for a solution. Whoever solves their respective puzzle first defines which transactions 152 are included in the next new block 151n, and the current pool 154 of unmined transactions is updated. The miners 104M then continue to race to create a block from the newly defined outstanding pool 154, and so forth. A protocol also exists for resolving any “fork” that may arise, which is where two miners 104M solve their puzzle within a very short time of one another such that a conflicting view of the blockchain gets propagated. In short, whichever prong of the fork grows the longest becomes the definitive blockchain 150.

In most blockchains the winning miner 104M is automatically rewarded with a special kind of new transaction which creates a new quantity of the digital asset out of nowhere (as opposed to normal transactions which transfer an amount of the digital asset from one user to another). Hence the winning node is said to have “mined” a quantity of the digital asset. This special type of transaction is sometime referred to as a “generation” transaction. It automatically forms part of the new block 151n. This reward gives an incentive for the miners 104M to participate in the proof-of-work race. Often a regular (non-generation) transaction 152 will also specify an additional transaction fee in one of its outputs, to further reward the winning miner 104M that created the block 151n in which that transaction was included.

Due to the computational resource involved in mining, typically at least each of the miner nodes 104M takes the form of a server comprising one or more physical server units, or even whole a data centre. Each forwarding node 104M and/or storage node 104S may also take the form of a server or data centre. However in principle any given node 104 could take the form of a user terminal or a group of user terminals networked together.

The memory of each node 104 stores software configured to run on the processing apparatus of the node 104 in order to perform its respective role or roles and handle transactions 152 in accordance with the node protocol. It will be understood that any action attributed herein to a node 104 may be performed by the software run on the processing apparatus of the respective computer equipment. Also, the term “blockchain” as used herein is a generic term that refers to the kind of technology in general, and does not limit to any particular proprietary blockchain, protocol or service.

Also connected to the network 101 is the computer equipment 102 of each of a plurality of parties 103 in the role of consuming users. These act as payers and payees in transactions but do not necessarily participate in mining or propagating transactions on behalf of other parties. They do not necessarily run the mining protocol. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application or software 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective user party 103 to create, sign and send transactions 152 to be propagated throughout the network of nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

The instance of the client application 105 on each computer equipment 102 is operatively coupled to at least one of the forwarding nodes 104F of the P2P network 106. This enables the wallet function of the client 105 to send transactions 152 to the network 106. The client 105 is also able to contact one, some or all of the storage nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. Each node 104 runs software configured to validate transactions 152 according to a node protocol, and in the case of the forwarding nodes 104F to forward transactions 152 in order to propagate them throughout the network 106. The transaction protocol and node protocol correspond to one another, and a given transaction protocol goes with a given node protocol, together implementing a given transaction model. The same transaction protocol is used for all transactions 152 in the blockchain 150 (though the transaction protocol may allow different subtypes of transaction within it). The same node protocol is used by all the nodes 104 in the network 106 (though it many handle different subtypes of transaction differently in accordance with the rules defined for that subtype, and also different nodes may take on different roles and hence implement different corresponding aspects of the protocol).

As mentioned, the blockchain 150 comprises a chain of blocks 151, wherein each block 151 comprises a set of one or more transactions 152 that have been created by a proof-of-work process as discussed previously. Each block 151 also comprises a block pointer 155 pointing back to the previously created block 151 in the chain so as to define a sequential order to the blocks 151. The blockchain 150 also comprises a pool of valid transactions 154 waiting to be included in a new block by the proof-of-work process. Each transaction 152 comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one of the one or more forwarding nodes 104F to which she is connected. E.g. this could be the forwarding node 104F that is nearest or best connected to Alice's computer 102. When any given node 104 receives a new transaction 152j, it handles it in accordance with the node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any storage node 104S that receives the transaction 152j will add the new validated transaction 152 to the pool 154 in the copy of the blockchain 150 maintained at that node 104S. Further, any forwarding node 104F that receives the transaction 152j will propagate the validated transaction 152 onward to one or more other nodes 104 in the P2P network 106. Since each forwarding node 104F applies the same protocol, then assuming the transaction 152j is valid, this means it will soon be propagated throughout the whole P2P network 106.

Once admitted to the pool 154 in the copy of the blockchain 150 maintained at one or more storage nodes 104, then miner nodes 104M will start competing to solve the proof-of-work puzzle on the latest version of the pool 154 including the new transaction 152 (other miners 104M may still be trying to solve the puzzle based on the old view of the pool 154, but whoever gets there first will define where the next new block 151 ends and the new pool 154 starts, and eventually someone will solve the puzzle for a part of the pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

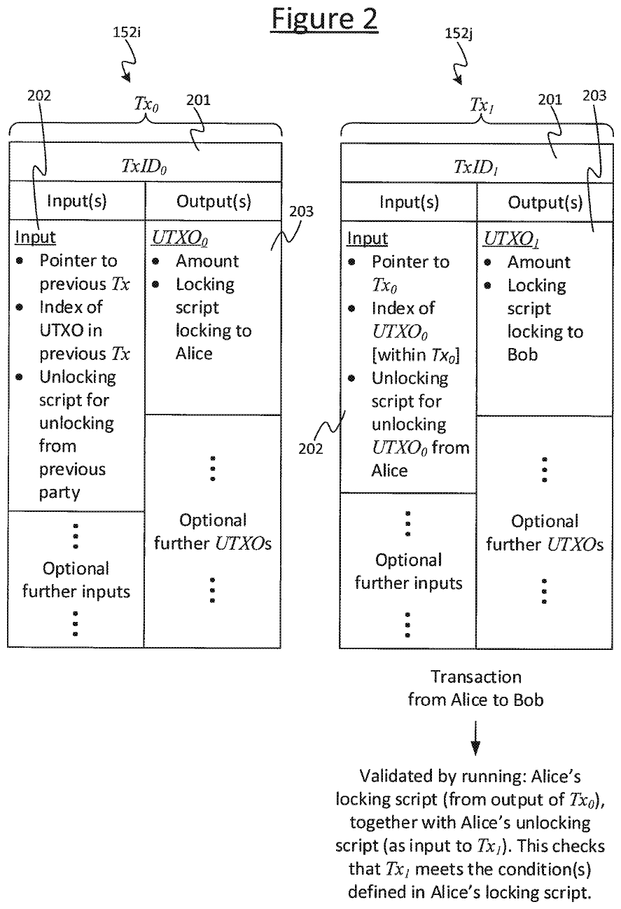

FIG. 2 illustrates an example transaction protocol. This is an example of an UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO specifies an amount of a digital asset (a store of value). It may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the miners 104M.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just an arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in the blockchain 150 at the time when Alice creates her new transaction Tx₁, or at least by the time she sends it to the network 106. It may already have been included in one of the blocks 151 at that time, or it may be still waiting in the pool 154 in which case it will soon be included in a new block 151. Alternatively Tx₀ and Tx₁ could be created and sent to the network 102 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given node 104. Nevertheless, a subsequent transaction (the descendent transaction or “child”) which points to a preceding transaction (the antecedent transaction or “parent”) will not be validated until and unless the parent transaction is validated. A child that arrives at a node 104 before its parent is considered an orphan. It may be discarded or buffered for a certain time to wait for the parent, depending on the node protocol and/or miner behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S). The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig PA] which requires a signature Sig PA of Alice in order for UTXO₀ to be redeemed (strictly, in order for a subsequent transaction attempting to redeem UTXO₀ to be valid).

[Checksig P_{A}] contains the public key P_{A} from a public-private key pair of Alice. The input 202 of Tx₁ comprises a pointer pointing back to Tx₁ (e.g. by means of its transaction ID, TxID₁, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}>which comprises a cryptographic signature of Alice, created by Alice applying her private key from the key pair to a predefined portion of data (sometimes called the “message” in cryptography). What data (or “message”) needs to be signed by Alice to provide a valid signature may be defined by the locking script, or by the node protocol, or by a combination of these.

When the new transaction Tx₁ arrives at a node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “<. . . >” means place the data on the stack, and “[. . . ]” is a function comprised by the unlocking script (in this example a stack-based language). Equivalently the scripts may be run one after another, with a common stack, rather than concatenating the scripts. Either way, when run together, the scripts use the public key P_{A} of Alice, as included in the locking script in the output of Tx₀, to authenticate that the locking script in the input of Tx₁ contains the signature of Alice signing the expected portion of data. The expected portion of data itself (the “message”) also needs to be included in Tx₀ order to perform this authentication. In embodiments the signed data comprises the whole of Tx₀ (so a separate element does to need to be included specifying the signed portion of data in the clear, as it is already inherently present).

The details of authentication by public-private cryptography will be familiar to a person skilled in the art. Basically, if Alice has signed a message by encrypting it with her private key, then given Alice's public key and the message in the clear (the unencrypted message), another entity such as a node 104 is able to authenticate that the encrypted version of the message must have been signed by Alice. Signing typically comprises hashing the message, signing the hash, and tagging this onto the clear version of the message as a signature, thus enabling any holder of the public key to authenticate the signature.

If the unlocking script in Tx₁ meets the one or more conditions specified in the locking script of Tx₀ (so in the example shown, if Alice's signature is provided in Tx₁ and authenticated), then the node 104 deems Tx₁ valid. If it is a mining node 104M, this means it will add it to the pool of transactions 154 awaiting proof-of-work. If it is a forwarding node 104F, it will forward the transaction Tx₁ to one or more other nodes 104 in the network 106, so that it will be propagated throughout the network. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the node 104 also needs to check whether the referenced UTXO in the preceding transaction Tx₀ is already spent (has already formed a valid input to another valid transaction). This is one reason why it is important for the blockchain 150 to impose a defined order on the transactions 152. In practice a given node 104 may maintain a separate database marking which UTXOs 203 in which transactions 152 have been spent, but ultimately what defines whether a UTXO has been spent is whether it has already formed a valid input to another valid transaction in the blockchain 150.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the winning miner, because nowadays the reward of the generation transaction alone is not typically sufficient to motivate mining. If Alice does not include a fee for the miner, Tx₀ will likely be rejected by the miner nodes 104M, and hence although technically valid, it will still not be propagated and included in the blockchain 150 (the miner protocol does not force miners 104M to accept transactions 152 if they don't want). In some protocols, the mining fee does not require its own separate output 203 (i.e. does not need a separate UTXO). Instead any different between the total amount pointed to by the input(s) 202 and the total amount of specified in the output(s) 203 of a given transaction 152 is automatically given to the winning miner 104. E.g. say a pointer to UTXO₀ is the only input to Tx₁, and Tx₁ has only one output UTXO₁. If the amount of the digital asset specified in UTXO₀ is greater than the amount specified in UTXO₁, then the difference automatically goes to the winning miner 104M. Alternatively or additionally however, it is not necessarily excluded that a miner fee could be specified explicitly in its own one of the UTXOs 203 of the transaction 152.

Note also that if the total amount specified in all the outputs 203 of a given transaction 152 is greater than the total amount pointed to by all its inputs 202, this is another basis for invalidity in most transaction models. Therefore such transactions will not be propagated nor mined into blocks 151.

Alice and Bob's digital assets consist of the unspent UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the storage nodes 104S, e.g. the storage node 104S that is closest or best connected to the respective party's computer equipment 102.

Note that the script code is often represented schematically (i.e. not the exact language). For example, one may write [Checksig P_{A}] to mean [Checksig P_{A}]=OP_DUP OP_HASH160<Pa>OP_EQUALVERIFY OP_CHECKSIG. “OP_ . . . ” refers to a particular opcode of the Script language. OP_CHECKSIG (also called “Checksig”) is a Script opcode that takes two inputs (signature and public key) and verifies the signature's validity using the Elliptic Curve Digital Signature Algorithm (ECDSA). At runtime, any occurrences of signature (‘sig’) are removed from the script but additional requirements, such as a hash puzzle, remain in the transaction verified by the ‘sig’ input. As another example, OP_RETURN is an opcode of the Script language for creating an unspendable output of a transaction that can store metadata within the transaction, and thereby record the metadata immutably in the blockchain 150. E.g. the metadata could comprise a document which it is desired to store in the blockchain.

The signature P_{A} is a digital signature. In embodiments this is based on the ECDSA using the elliptic curve secp256k1. A digital signature signs a particular piece of data. In embodiments, for a given transaction the signature will sign part of the transaction input, and all or part of the transaction output. The particular parts of the outputs it signs depends on the SIGHASH flag. The SIGHASH flag is a 4-byte code included at the end of a signature to select which outputs are signed (and thus fixed at the time of signing).

The locking script is sometimes called “scriptPubKey” referring to the fact that it comprises the public key of the party to whom the respective transaction is locked. The unlocking script is sometimes called “scriptSig” referring to the fact that it supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Digital Asset Distribution

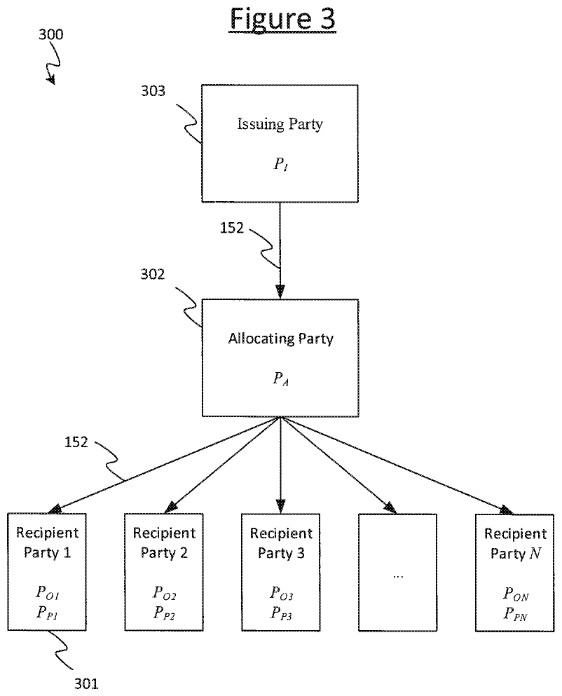

FIG. 3 illustrates an example system 300 for allocating amounts (i.e. payments) of a digital asset using blockchain transactions. The system 300 comprises one or more recipient parties 301 and an allocating party (“the allocator”) 302. There may be any number of recipient parties (“recipients”) 301, as shown by labels 1 to N in FIG. 3. Each party operates respective computer equipment. For instance, referring to FIG. 1, one or more of the recipients 301 may take the role of Alice 103a or Bob 103b, who operate their respective computer equipment 102a, 102b. Each arrow in FIG. 3 represents the transfer of an amount of a digital asset using a blockchain transaction 152.

The system 300 may also comprise an issuing party (“the issuer”) 303 who operates respective computer equipment. In some embodiments the issuer 303 and the allocator 302 are the same party. Alternatively, the issuer 303 and the allocator 302 may be different parties.

The allocator 302 and/or the issuer 303 may take the form of a server comprising one or more physical server units, or even a whole data centre. Alternatively, the allocator and/or the issuer could take the form of a user terminal or a group of user terminals networked together. That is, the allocator and/or the issuer may be an individual user or a group of users such as an organisation, e.g. a company, an academic institution, a charity, etc. In general, the allocator and/or the issuer comprises computer equipment. The computer equipment comprises processing apparatus comprising one or more processors, e.g. one or more central processing units (CPUs), accelerator processors, application specific processors and/or field programmable gate arrays (FPGAs). The computer equipment also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive. The memory of the allocator stores software configured to run on the processing apparatus of the node computer equipment in order to perform its respective role or roles. It will be understood that any action attributed herein to the allocator and/or the issuer may be performed by the software run on the respective processing apparatus of the allocator's or the issuer's computer equipment. The allocator and/or the issuer may communicate with the recipient parties 301 (e.g. Alice and Bob), e.g. via the internet 101.

Each party is associated with the blockchain 150 via a unique public key. The public keys may be Elliptic Curve Cryptography public keys. As shown in FIG. 3, each recipient 301 is associated with the blockchain 150 via their own ownership public key P_{Oi}, and the allocator 302 is associated with the blockchain 150 via a allocating public key P_{Ai}. For instance, a first recipient (recipient i=1) owns a first ownership public key P_{O1}, a second recipient (recipient i=2) owns a second ownership public key P_{O2}, and so on, with the N^{th} recipient (recipient i=N) owning an N^{th} ownership public key P_{ON}. It will be appreciated that first, second, . . . , N^{th}, etc. are merely labels used to distinguish between different recipients and their ownership public keys. In examples where the system 300 comprises the issuer 303, the issuer 303 is associated with the blockchain 150 by an issuing public key P_{I}. Each public key forms part of a public-private key pair, the public key being generated based on the private key. In general, private keys are kept secret and not shared with other parties or published.

One or more of the public keys discussed above may be certified public keys. A certified public key is associated with a public key certificate issued by a certificate authority. The certificate is a digital certificate that can be used to prove ownership of the associated public key. The certificate can be used to prove that the certificate authority issuing the certificate attests to the ownership of the public key.

The allocator 302 has access to an allocation (i.e. a store) of a digital asset. A digital asset may represent a mapping to a real-world asset. For example, a specific amount of the digital asset may represent a specific amount of the real-world asset. As an example, the digital asset may represent the ownership of a house, a piece of art, a patent, etc., and the allocator may be responsible for transferring (partial) ownership of the asset. The allocator may, for instance, want to transfer 50% ownership of the asset to a first recipient and 50% ownership of the asset to a second recipient. The digital asset may be digital tokens. That is, the allocation of the digital asset may be a plurality of tokens. Each token may be pegged to an amount of the real-world asset. The tokens may represent, for example, votes, time-periods of electrical energy, tickets to an event, etc. For example, the allocator may be responsible for allocating (i.e. distributing) tokens to recipients 301. The recipients may then redeem their tokens, e.g. for entry into a music festival. As another example, the tokens may enable access to a subscription service (e.g. a media streaming service). Each token may represent a period of access to the service (e.g. one month). The allocating party may allocate a recipient party a set number of tokens (e.g. twelve tokens for a year-long subscription) which may be spent to access the service.

Optionally, the issuer 303 may issue the allocation of the digital asset to the allocator 302. That is, the issuer may generate one or more blockchain transactions that, together, transfer the allocation of the digital asset from the issuer to the allocator. Specifically, the blockchain transactions transfer ownership of the digital asset from the issuer's blockchain address (e.g. the issuing public key P_{I} or an address based on P_{I}) to the allocator's public key P_{A}. As an example, the issuer may entrust the allocator to distribute amounts of the digital asset to the recipients, thus relieving the issuer from generating and transmitting a (large) number of blockchain transactions. In this example, the issuer need only transfer the allocation of the digital asset to the allocator's allocating address (e.g. the public key P_{A} or a P2PKH based on P_{A}). That is, the issuer need only enact a single transaction.

As explained in more detail above, the output(s) of a blockchain transaction lock an amount of the digital asset to a particular public key. The corresponding private key is required to access (e.g. transfer, use, spend) the amount of the digital asset locked to the public key. Therefore, in this example, only the allocator 302 can access the allocation of the digital asset by using the private key S_{A} paired with P_{A}. Initially, the allocation of the digital asset is held at (i.e. locked to) a first allocating public key P_{A} paired with a first allocating private key S_{A}. As explained below, the allocator may make several payment allocations. Each payment allocation (i.e. each iteration of allocating amounts of the digital asset) may involve a different public-private key pair. For instance, the first iteration may make use of P_{A}⁽¹⁾ and S_{A}⁽¹⁾, the second iteration may make use of P_{A}⁽²⁾and S_{A}⁽²⁾, and the n^{th} iteration may make use of P_{A}⁽ⁿ⁾ and S_{A}⁽ⁿ⁾. For brevity, the notation P_{A} is used to represent P_{A}⁽¹⁾.

The allocator 302 is required to transfer amounts of the allocated amount of the digital asset to the set of recipients 301. The set may comprise a single recipient or multiple recipients. Each recipient owns a unique ownership private key S_{Oi} which is paired with a respective ownership public key P_{Oi}. The allocator obtains the set of ownership public keys P_{Oi} corresponding to the recipients who are to receive an amount of the digital asset allocation. There are several ways in which the set of ownership public keys P_{Oi} may be obtained. For example, each recipient may register their individual ownership public key P_{Oi} with (i.e. make available to) the allocator and/or the issuer 303. The registration of public keys will be discussed below. Note that the respective amounts transferred to the recipients may or may not be equal, as will be discussed below.

Note that the allocator 302 could simply transfer an amount of the digital asset to a recipient's ownership public key. However, if the recipient's ownership private key was compromised, all future payments to the recipient would be compromised. However, if the recipient's payment private key is compromised, only that payment is compromised. A new payment public-private key pair can be generated based on P_{Oi} and used as the next payment address. P_{Oi} may be thought of as an identifier of a recipient whilst P_{Pi}is a redeemable voucher/token (i.e. redeemable for a real-world asset). Periodic payments are retrieved from an address based on P_{Pi} using the ownership key P_{Oi} as a certified point of access. Since P_{Pi} may be updated with each payment, its compromise can only result in a limited theft (i.e. only the amount of the digital asset transferred to the address based on that iteration of P_{Pi}). A compromise of P_{Oi} is equivalent to a breach of identity and potential loss of all future payments.

Instead the allocator 302 generates, for each ownership public key P_{Oi}, a corresponding payment public key P_{Pi}. For a given recipient 301, their payment public key P_{Pi} is generated using at least both of the recipient's ownership public key P_{Oi} and the allocator's public key P_{Ai}. For example, for the first round of allocations, the first recipient's payment public key is generated using at least the first recipient's ownership public key P_{Oi} and the allocator's first allocating public key P_{A}. The use of both the recipient's ownership public key and the allocator's public key creates a link between the two parties.

In the case where multiple cycles of allocating payments are enacted, a first set of payment public keys are generated using the allocator's first public key P_{A}. Later allocation iterations may involve generating a second set of payment public keys using a second, different allocating public key P_{A(2)}. The generation of different allocator public keys will be discussed below.

The allocator 302 controls the payment public keys P_{Pi} that act as, or are used to generate, payment addresses for each recipient. The set of payment keys P_{Pi} allows any party (e.g. the issuer 303, recipients 301, regulatory bodies, etc.) to verify the payment address and, for instance, the amount of the digital asset transferred to that payment address at any point in time.

Once the set of payment public keys P_{Pi} has been generated, the allocator 302 can generate one or more blockchain transactions to transfer payments of the digital asset store to intended recipients, whereby the transactions transfer a respective amount of the digital asset from the allocator's address (based on the allocating public key P_{A}) to a respective recipient's payment address (based on that recipient's payment public key P_{Pi}). The payments may be transferred in a single transaction. That is, a single transaction may have a plurality of outputs, whereby each output transfers a share of the digital asset to a different payment address (i.e. to a different recipient). Alternatively, the payments may be transferred using more than one transaction, e.g. each transaction may transfer a share of the digital asset to a single, different payment address (i.e. a different recipient).

The allocator 302 may transmit the transaction(s) to the blockchain network 106, i.e. to one or more nodes 104 connected to the blockchain. If the transaction(s) are deemed to be valid transactions by satisfying the conditions of the blockchain protocol (discussed above), the transaction(s) will be committed to the blockchain 150 and act as an immutable public record of the amounts allocated.

Once the transactions are committed to the blockchain, the amounts of the digital asset can be accessed under certain conditions. One of those conditions is that a signature generated using a payment private key S_{Pi} corresponding to a payment public key P_{Pi} is provided in a transaction attempting to access the amount of the digital asset. In other words, if a share of the digital asset is transferred to a payment address based on the first public payment key P_{P1}, a first private payment key S_{P1} from a first public-private key pair is required to transfer that share to another blockchain address. In order to access their share of the digital asset, each recipient 301 must generate a payment private key S_{Pi} corresponding to their payment public key P_{P1}. This requires knowledge of the allocator's private key S_{A}.

The allocator 302 may publish the private key S_{A} on the blockchain, e.g. in a (provably) unspendable output of a blockchain transaction. For instance, S_{A} may be included in an OP_RETURN output of a transaction. An OP_RETURN opcode marks an output of a transaction as invalid, guaranteeing that no input of a later transaction could spend that output. Alternatively, the allocator may publish the private key S_{A} off-chain, e.g. by publishing on a website and/or by transmitting to the recipients 301 via other secure means of communication, e.g. encrypted email.

The following describes one technique for generating payment public keys P_{Pi} for use by the allocator 302 and the recipient(s) 301. The payment public keys P_{Pi} can be derived from the allocating private key S_{A}, along with the private ownership public key S_{Oi} as follows:

P_{Pi}=S_{Pi}·G=(S_{Oi}+S_{A})·G

P_{Pi}=P_{A}+S_{Oi}·G

P_{Pi}=P_{A}+P_{Oi}

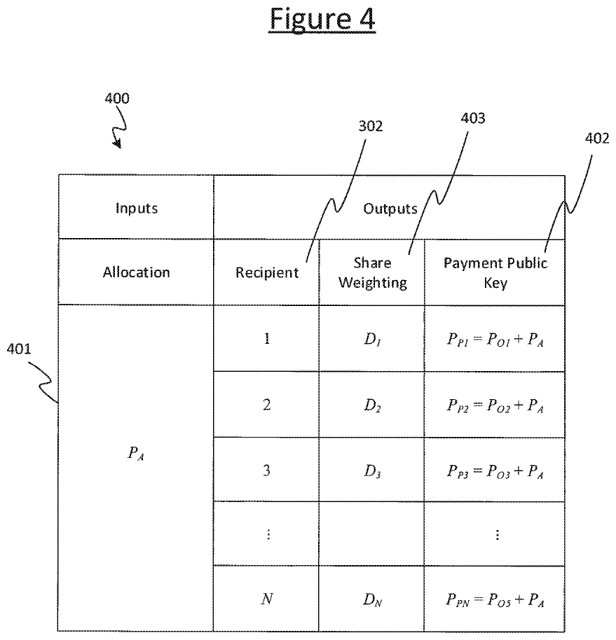

The use of public key addition here creates a link between two addresses and hence two parties (the allocator 302 and the recipient 301) without the need for further communication. Using the individual payment public keys (P_{Pi}=P_{A}+P_{Oi}) means that the allocator can distribute the allocation of the digital asset from P_{A} into separate outputs across the total set of addresses P_{Oi}. An example transaction 400 is shown in FIG. 4.

As shown, the transaction 400 comprises an input 401 for transferring an allocation of the digital asset from the allocator's allocating public key P_{A} and a plurality of outputs. In this example there are N outputs. Each output transfers a respective amount 402 of the digital asset to a respective payment public key 403 belonging to a respective recipient 302. It will be appreciated that FIG. 4 is a representation of a transaction. In reality, the input of the transaction would comprise an unlocking script and each output of the transaction would comprise a locking script.

The allocator 302 distributes amounts of the digital asset, using blockchain transaction(s), to the set of payment public keys P_{P1}. The allocator may then publish the secret allocating private key S_{A} on-chain using an OP_RETURN declaration, or otherwise, so that each recipient 301 can calculate P_{Pi} and retrieve their respective amounts independently.

In order to access (i.e. spend) their amount of the digital asset, a recipient 301 has to be able to determine the payment address to which their amount was transferred. Recall that the payment address is generated based on the recipient's ownership public key P_{Oi} (and only the recipient knows the corresponding private key S_{Oi}) and the allocator's public key P_{A}. Therefore, the recipient can calculate their own payment public key P_{Pi} and their payment address (e.g. P2PKH). Furthermore, the recipient must be able to determine the payment private key S_{Pi} paired with their payment public key P_{Pi}. The recipient has their ownership private key S_{Oi} and the allocator's private key S_{A}. Therefore, the recipient can generate the payment private key S_{Pi} using the equations above, i.e. S_{Pi}=S_{Oi}+S_{A}.

For successive allocations, the allocator's public key P_{A} must be updated since the corresponding private key S_{A} has been published such that there will exist n total allocating public-private key pairs for n allocations. After the first allocation (n=1) to public key P_{A}⁽¹⁾ with corresponding private key S_{A}⁽²⁾, the allocator 302 generates an updated public key P_{A}⁽²⁾ with corresponding updated private key S_{A}⁽²⁾. When allocating amounts of the digital asset for the second allocation, the allocator generates a second set of payment public keys P_{Pi}⁽²⁾ as before, with the exception that the updated public key is used. That is, P_{Pi}⁽²⁾=P_{Oi}P_{A}⁽²⁾, or in general P_{Pi}⁽ⁿ⁾=P_{Oi}+P_{A}⁽ⁿ⁾. The allocator can then generate one or more transactions that transfer amounts of a second allocation to updated payment addresses of the recipients. The updated payment addresses may be the updated public keys themselves, or a hash of the updated public keys.

The public key can be updated in several ways. In some examples, the public key is updated randomly. In other examples, the following hybrid scheme is used where the n^{th} public key P_{A}⁽ⁿ⁾ is derived from the sum of a randomly (or otherwise, e.g. using a shared secret) generated public key P_{An} and the list of previous public keys, ΣP_{Aj}∀j=[1, . . . , n−1], to create a chain between a sequence of allocations:

| Allocation Iteration | Allocating Public Key Structure |
|---|---|
| 1 | P_{A1} |
| 2 | P_{A2} + P_{A1} |
| 3 | P_{A3} + P_{A2} + P_{A1} |
| n | ${P}_{An} + {\sum }_{j = 1}^{n - 1} {P}_{Aj}$ |

In this example, the updated allocated public key equals a newly (e.g. randomly) generated key plus the sum of all the previous public keys. This public key structure creates an audit trail of payments, linking each updated public key to the previous one. In this way, a chain of payments is created. A new public key is not generated purely from the previous one since this would increase the attack surface (i.e. if the old public key was compromised, an attacker would be able to generate all future addresses too).

Optionally, each recipient 301 may update their ownership public key P_{Oi}. For instance, the (certified) ownership public key P_{Pi} may be updated with a deterministic component derived from a shared secret (shared between a recipient and the allocator 302), as described in WO2017/145016. A summary of the techniques described in WO2017/145016 is as follows:
1. Alice creates a message and hashes it.
2. Alice uses the hashed message to create a secondary private-public key pair via ECC addition.
3. Alice sends the hashed message to the allocator, signed for by her secondary private key.
4. The allocator validates Alice's signature.
5. The allocator uses the hashed message to create a secondary private-public key pair via Elliptic Curve Cryptography (ECC) addition.
6. Alice and the allocator are now both able to calculate each other's secondary public keys.
7. Alice and the allocator multiply their individual secondary private keys with each other's secondary public keys to derive a shared secret (commutative law).
8. Hashing the hashed message (and hashing the hash of the hashed message etc.) enables the creation of a hierarchy of shared secrets, where only the original message need be known.

Note that in some examples the allocator may perform the actions attributed to Alice and the recipient may perform the actions attributed to the allocator.

A sequence of ownership public keys P_{Oi}⁽¹⁾, P_{Oi}⁽²⁾, . . . , P_{Oi}⁽ⁿ⁾can be generated using the above described method. A second ownership public key P_{Oi}⁽²⁾can be used by the recipients and the allocator for a second cycle of allocations. Each allocation may use an updated ownership public key, with the n^{th} cycle using the n^{th} updated ownership public key P_{Oi}⁽ⁿ⁾. This enhances the security of transactions through regular key updates, while also retaining a reference to the initial (certified) ownership public key P_{Oi}, e.g. to create an audit trail.

The allocator may use the updated ownership public keys to generate updated payment public keys for successive allocations using P_{Pi}⁽ⁿ⁾=P_{Oi}⁽ⁿ⁾+P_{An}.

In some examples each recipient may not receive an equal share of the digital asset store. That is, some recipients may receive a larger share than others. Each ownership public key P_{Oi} may be encoded with a (percentage) weighting Dᵢ of the allocation of the digital asset. The allocator may maintain and store a record of the relative weighting of each share Dᵢ, to ensure that the correct proportion of the allocation is distributed to each payment public key P_{Pi} at the time of distribution. Note that ΣDᵢ=100%.

The allocator 302 may also maintain and store a record of the set of active ownership public keys P_{Oi}∀i=[0 . . . n]. For example, some recipients may transfer their ownership to a different recipient (e.g. an existing recipient or a new recipient), or to the issuer, thus revoking their own ownership public key P_{Oi}. Therefore, a list of ownership public keys P_{Oi} may need to be obtained (or refreshed) to identify any keys that have been newly added or revoked from the list of active recipients. The update may be in real time or at the time that the allocation transaction(s) are generated.

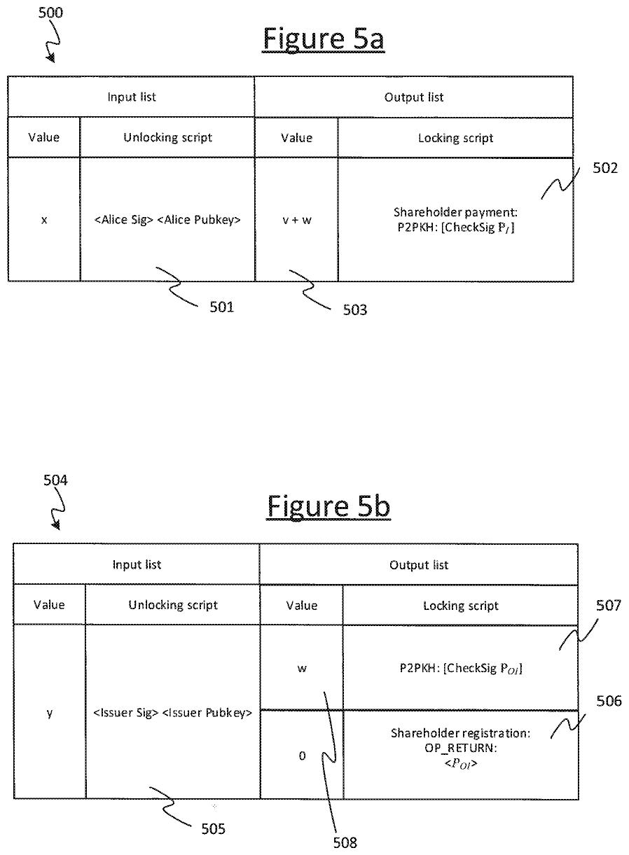

As discussed above, Alice may register her ownership public key on the blockchain which allows the allocating party to obtain her ownership public key. FIGS. 5a and 5b illustrate example transactions for registering Alice's ownership public key. As shown in FIG. 5a, transaction 500 is sent from Alice to the issuer. That is, the transaction 500 comprises an input having an unlocking script 501 comprising Alice's signature and Alice's public key. This enables Alice to spend an output, of a previous blockchain transaction, that has been sent to Alice. The transaction 500 comprises an output having a locking script 502 configured to transfer an amount of the input to the issuer (e.g. a pay-to-public-key-hash to the issuer's public key). This acts as a shareholder payment from Alice to the issuer. Note that this shareholder payment could be implemented off-block, e.g. using a bank transfer, etc. The input comprises a value 503 equal to v+w. Here, the value is a payment for the share amount, and w is a representative value representing a weighting D linked to Alice. Note that the value w is optional.

FIG. 5b illustrates an example transaction 504 which includes Alice's ownership public key. Transaction 504 is sent from the issuer to Alice. That is, transaction 504 comprises an input having an unlocking script comprising the issuer's signature and the issuer's public key. The transaction 504 comprises two outputs. A first output comprises Alice's ownership public key in an unspendable transaction output 506, e.g. an OP_RETURN output. This registers Alice's ownership public key on the blockchain 150. A second output 507 comprises a pay-to-public key hash to Alice. This allows Alice to revoke (or deactivate) her ownership public key, e.g. to transfer her share to a different party. Alternatively, the second output 507 may comprise a pay-to-public key hash to the issuer. This would allow the issuer to revoke Alice's ownership public key. As another alternative, the second output 507 may require n-of-m signatures in order to spend the output value 508. For instance, the second output 507 may require one or both of Alice and the issuer's public key.

One method for maintaining a list of active ownership public keys P_{Oi} and/or weightings Dᵢ will now be described with reference to FIGS. 5a and 5b. At the time of registering a recipient's ownership public key P_{Oi}, the recipient 301 or the issuer 303 (with the issuing public key P_{I}) may transfer a representative amount of a digital asset (the same digital asset in the store of digital asset or a different type of digital asset) to the recipient's ownership public key P_{Oi}. For example, the digital asset may be a native token. The representative amount denotes active ownership (i.e. entitlement) to the amounts of the digital asset. In some examples, during registration of the ownership public key P_{Oi}, a multi-signature transaction may be set up by either the issuer or the recipient such that both parties validate the transaction, thereby agreeing on the weighting (e.g. percentage) Dᵢ of amounts allocated to the recipient.

The ratio mapping the representative amount to the relative weighting Dᵢ may be left to the discretion of the issuer 303. For example, if a recipient 301 is to receive 25% of the allocation of the digital asset, the representative amount may be 25 units of a token mapped to the digital asset. The representative amount may be sent to the recipient's ownership public key P_{Oi} in a blockchain transaction. Such a transaction is shown in FIG. 5a. In this example, a recipient (say Alice) is transferring, via a first output, an amount v to the issuer's public key P_{I}. This acts as payment for an amount of the digital asset. In the example transaction of FIG. 5b, the issuer transfers a representative amount w, representing a D₁=w % share of the digital asset, to Alice's ownership public key P_{O1}. This transaction links Alice's ownership public key P_{O1} to her weighting ₁.

If the output 507 to Alice is not redeemed (i.e. spent), the outputs of her transaction are classified as unspent transaction outputs (UTXO). The set of UTXOs throughout the blockchain can be easily queried. That is, the UTXO set acts like a universal memory of the blockchain. The active holder of an ownership public key P_{O1} will appear in the UTXO set. Therefore, the allocator can query the UTXO set for ownership public keys (e.g. certified ownership public keys) P_{Oi} and their respective weightings Dᵢ, in order to determine who to transfer payments of the digital asset to along with how much of the digital asset to transfer.

A recipient 301 (e.g. Alice) may decide to transfer their allocation back to the issuer 303. To do this, Alice can generate a transaction that transfers the representative amount w back to the issuer. This has the effect that Alice's ownership public key P_{O1} will no longer appear in the UTXO set. Alternatively, Alice may choose to transfer (e.g. trade) her ownership to a new recipient's ownership public key P_{O2} using a blockchain transaction. The transaction may be a multi-signature transaction that requires the issuer's signature. That way transfers may only occur if approved by the issuer.

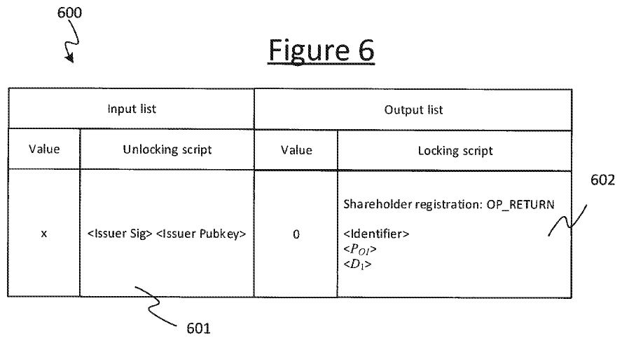

An alternative method for registering ownership public keys and maintaining a list of active ownership public keys P_{Oi} and weightings Dᵢ will now be described with reference to FIG. 6.

The method involves registering an ownership public key P_{Oi} in an unspendable transaction output. For example, the issuer 303 may declare the weighting D₁ of the amount represented by Alice's ownership public key P_{O1} in an unspendable output during the initial registration process. In this sense, an ownership public key acts as a token pegged to a weighting Dᵢ. The output may be unspendable due to, e.g., comprising an opcode that causes the output (locking) script to fail when executed. In some such examples, an OP_RETURN output may be included in a transaction with an accredited identifier (e.g. a 4-byte prefix) anytime an ownership public key P_{Oi} is registered or revoked. The identifier may be accredited by the issuer or a trusted third party. The output may be generated by a recipient or by the issuer.

An example transaction is shown in FIG. 6. The transaction 600 comprises an input 601 transferring an amount x (the transaction fee) from Alice's public key and an output 602. The output 602 is an unspendable transaction output. The output 602 comprises the accredited identifier 603, Alice's ownership public key P_{O1} and Alice's weighting D₁.

The allocator 302 may identify transactions with specific identifiers, e.g. specific prefixes. For example, the allocator may store the list of ownership public keys which could then be updated by identifying transactions with specific accredited identifiers. An active ownership public key may be represented by a specific identifier (e.g. a prefix), which the allocator could check at the time that allocations are due. Any ownership public keys that are revoked from this list may be represented by a different identifier (e.g. a prefix) assigned to past holders through an OP_RETURN transaction at the time of revocation (e.g. upon trading of shares).

It is assumed above that the allocator 302 is a trusted third party. In an alternative scenario or as an additional security measure, the shared allocating private key S_{A} could be stored in an enclave within a trusted execution environment, e.g. such as SGX (Software Guard Extensions), to protect the allocation of the digital asset associated with P_{A}. All automating code defined in the allocator's software could also be run in the trusted execution environment to avoid compromising the secret S_{A} until the payments have been securely allocated to the payment public keys P_{Pi}.

To summarise, public keys can be used to denote ownership of a digital asset. At registration, each holder registers their individual ownership public key, e.g. with the issuing party or the allocating party. The total number of public keys issued is equivalent to the total number of holders n. The use of public, e.g. Elliptic Curve Cryptography (ECC) keys to denote asset ownership may be used for any one or more of the following applications.
Security—ECC public keys are provably secure. Ownership of a share can be proved through a digital signature. Using the underlying cryptographic system in this way to denote share ownership offers a smaller codebase and reduces the attack surface.
Regulation—Know Your Customer information submitted at the time of public key issuance enables regulatory compliance. A public key can be certified using a certificate authority.
Traceable shares—Organisations/regulatory bodies and the holders themselves can identify the full list of holders within a list of allocated shares using the set of unique public keys. This ensures transparency for both parties (e.g. a company and its shareholders) without revealing personal information or the identity of the holder.

The following describes example use cases using the above embodiments. The allocation of payments may be used for, amongst others: dividend payments; coupons for bond and treasury instruments; unit trust allocations; dispersing insolvency allocations, partnership allocations, and fair distributions; payment of monthly wages; loan repayments; and payment of royalties, e.g. to an artist from sale profits.

A particular use case will now be described. An issuer (e.g. a company) Kangaroo Ltd uses a trusted third party that offers a token protocol on the blockchain. The protocol uses a request-response mechanism to generate smart contracts. Kangaroo Ltd. wishes to distribute shares in its digital asset to its shareholders. Below is a step-by-step outline of the procedure that the participants follow according to embodiments described above. The following lists the name of the parties involved in the example allocation scheme, their role and any public-private key pairs that they own.
Alice—the shareholder—P_{O1}, P_{P1}
Bob—the issuer (e.g. Kangaroo Ltd.)—P_{I}
Carol—the allocator—P_{A}
Token service (TS)—the smart contract provider—smart contract address

To register ownership of a share in the digital asset:
1. Alice sends a transaction to the smart contract address requesting a 1% share in Kangaroo Ltd's digital assets.
2. Bob sees Alice's shareholder request and accepts her request.
3. Alice transfers an amount of a digital asset for the shares to Bob.
4. Bob sends an OP_RETURN statement declaring the value of Alice's shares that are attributed to her individual share ownership key P_{O1}.

To allocate shares of the digital asset:
1. At the time that the shares are due to be allocated, Kangaroo Ltd transfers their allocation of the digital asset into P_{A}.
2. Carol retrieves the funds in P_{A} and refers to her list of active ownership public keys in each OP RETURN statement. Carol can obtain this information from the TS that has been authenticated by Bob.
3. Carol allocates the shares to each payment public key defined by the set of public keys P_{Pi}=P_{Oi}+P_{A} according to the percentage holding associated with each P_{Oi}.
4. Carol publishes the secret S_{A} on-chain in an OP_RETURN transaction.
5. Alice can now calculate P_{P1}=P_{O1}+P_{A} from which she is able to retrieve her quarterly dividends payment.

It will be appreciated that the above embodiments have been described by way of example only. More generally there may be provided a method, apparatus or program in accordance with any one or more of the following Statements.

Statement 1: A computer-implemented method of generating at least one transaction associated with a blockchain, the at least one transaction being for distributing amounts of an allocation of a digital asset from an allocating party to one or more recipient parties, wherein the allocating party is associated with an allocating public key linked with the allocation, wherein each recipient party is associated with a respective ownership public key; and wherein the method comprises: obtaining a respective ownership public key of each of the one or more recipient parties; for each of the one or more recipient parties, generating a respective payment public key based on (i) the ownership public key associated with that recipient user, and (ii) the allocating public key; and generating the at least one transaction, wherein the at least one transaction comprises one or more output scripts, each output script configured to transfer a respective amount of the allocation to a respective payment address, the respective payment address being based on the respective payment public key.

For example, a payment address may be a payment public key. Alternatively, the payment address may be a P2PKH, i.e. a hash of the payment public key.

Statement 2: The method of statement 1, comprising: causing the at least one transaction to be included in the blockchain.

For example, said causing comprises transmitting the at least one transaction to one or more nodes of the blockchain network for inclusion in the blockchain.

Statement 3: The method of statement 2, wherein the allocating public key is paired with an allocating private key, and wherein the method comprises making the allocating private key available to the one or more recipient parties.

For example, the allocating private key may be published on-chain in a transaction (e.g. using an unspendable transaction output or a private key puzzle in a spendable output). Alternatively, the private key may be published off-chain, e.g. transmitted to the recipient parties using a side channel.

Statement 4: The method of any of statements 1 to 3, wherein each ownership public key is associated with a respective weighting, and wherein the method comprises: for each recipient party, obtaining the respective weighting associated with their ownership public key, wherein the respective amount of the allocation to be transferred to that recipient party is based on the obtained respective weighting.

Statement 5: The method of any of statements 1 to 4, wherein the blockchain comprises a plurality of unspent transaction outputs, wherein each unspent transaction output is linked with a respective unspendable transaction output comprising the ownership public key of a respective recipient party, and wherein said obtaining of the respective ownership public key comprises obtaining the respective ownership public key from the unspendable transaction output linked with a respective unspent transaction output.

Statement 6: The method of statement 5 as dependent on statement 4, wherein each unspent transaction output comprises a respective representation of the weighting; and said obtaining of the respective weighting comprises, for each recipient party, obtaining the respective weighting based on the respective representation in the unspent transaction output linked with the respective unspendable transaction output comprising the ownership public key of that recipient party.

For example, the weightings may be obtained by scanning the plurality of unspent transaction outputs for unspent transaction outputs linked with a registered ownership public key.

Statement 7: The method of statement 6, wherein each representation of the weighting is a representative amount of the digital asset.

Statement 8: The method of any of statements 5 to 7, comprising:
determining whether the respective ownership public key of each of the one or more recipient parties is an active ownership public key based on whether the respective ownership public key is linked with an unspent transaction output; and
said generating of the respective payment key comprising only generating respective payment keys for active ownership public keys.

Statement 9: The method of any of statements 1 to 8, wherein the blockchain comprises a plurality of transactions having unspendable transaction outputs, each unspendable transaction output comprising the ownership public key of a respective recipient party, and wherein said obtaining of the respective ownership public key comprises obtaining the respective ownership public key from the respective unspendable transaction output.

Statement 10: The method of statement 9 as dependent on at least statement 4, wherein each unspendable transaction output comprises a representation of the weighting associated with the respective ownership public key; and wherein said obtaining of the respective weighting comprises, for each recipient party, determining the respective weighting based on the representation in the respective unspendable transaction output.

Statement 11: The method of statement 9 or statement 10, comprising identifying each unspendable transaction output based on a predetermined identifier included within the at least one unspendable transaction output.

Statement 12: The method of statement 11, comprising: for each recipient user, determining whether their respective ownership public key is an active ownership public key based on whether the at least one unspendable transaction output comprising their respective ownership public key comprises the predetermined identifier; and said generating of the respective payment key comprising only generating respective payment keys for active ownership public keys.

Statement 13: The method of any of statements 4 to 12, comprising:
maintaining a record of the respective weighting of each recipient user; and/or maintaining a record of the active ownership public keys.
Statement 14: The method of any of statements 1 to 13, wherein the at least one transaction is a single transaction, the single transaction comprising the one or more output scripts.

Statement 15: The method of any of statements 1 to 14, wherein one or more payment addresses are escrow payment addresses, and wherein the method comprises withholding the allocating private key from at least one of the one or more recipient parties until at least one condition is fulfilled by said at least one recipient party.

Statement 16: The method of any of statements 1 to 15, comprising: generating an updated allocating public key; for each of the one or more recipient parties, generating an updated respective payment public key based on (iii) the ownership public key associated with that recipient party, and (iv) the updated allocating public key; and generating the at least one transaction, wherein the at least one transaction comprises one or more output scripts, each output script configured to transfer a respective amount of the allocation to a respective updated payment address of a respective recipient party, the respective updated payment address being based on the respective updated payment public key.

Statement 17: The method of statement 16, comprising, publishing an updated allocating private key paired with the updated allocating public key.

Statement 18: The method of any of statements 1 to 17, wherein the allocation is transferred, using a transaction of the blockchain, from an issuing public key associated with an issuing party to an allocating address based on the allocating public key.

Statement 19: The method of statement 3 or any subsequent statement as dependent thereon, wherein the allocating private key is stored within a trusted execution environment, and wherein the allocating private key is only accessible by the allocating party after said causing of the at least one transaction to be included in the blockchain.

Statement 20: Computer equipment of the allocating party, comprising: memory comprising one or more memory units; and processing apparatus comprising one or more processing units, wherein the memory stores code arranged to run on the processing apparatus, the code being configured so as when on the processing apparatus to carry out the method of claim perform the method of any of statements 1 to 19.

Statement 21: A computer program embodied on computer-readable storage and configured so as, when run on computer equipment of the allocating party, to perform the method of any of statements 1 to 19.

Statement 22: A computer-implemented method of accessing an amount of a digital asset, the amount of the digital asset being transferred from an allocating public key of an allocating party to a payment address of a recipient party using a transaction associated with a blockchain, wherein the recipient party is associated with an ownership public key; and wherein the method comprises: causing a first transaction comprising the ownership public key to be included in the blockchain; obtaining an allocating private key paired with the allocating public key; determining a payment address based on a payment public key, wherein the payment public key has been generated based on the ownership public key and the allocating public key; and determining, using the allocating private key, a payment private key paired with the payment public key.

Statement 23: The method of statement 22, comprising: generating a second transaction, wherein the second transaction transfers the amount of the digital asset from the payment address to a different address of the blockchain.

Statement 24: The method of statement 22 or statement 23, wherein the blockchain comprises a third transaction having an unspent transaction output, wherein the unspent transaction output comprises an amount of the digital asset linked to the ownership public key, and wherein the method comprises generating a fourth transaction that transfers the amount of the digital asset linked to the ownership public key to a public key of a different party of the blockchain.

Statement 25: The method of statement 24, wherein the different party is either: (i) a different recipient party associated with a different ownership public key, or (ii) an issuing party, wherein the allocation is transferred, using a transaction of the blockchain, from an issuing public key associated with the issuing party to the allocating public key of the allocating party.

Statement 26: Computer equipment of the recipient party, comprising: memory comprising one or more memory units; and processing apparatus comprising one or more processing units, wherein the memory stores code arranged to run on the processing apparatus, the code being configured so as when on the processing apparatus to carry out the method of claim perform the method of any of statements 22 to 25.

Statement 27: A computer program embodied on computer-readable storage and configured so as, when run on computer equipment of the recipient party, to perform the method of any of statements 22 to 25.

According to an aspect disclosed herein, there may be provided a method comprising the actions of the recipient party, the allocating party, and the issuing party.

According to an aspect disclosed herein, there may be provided a system comprising the computer equipment of the recipient party, the allocating party, and the issuing party.

Other variants or use cases of the disclosed techniques may become apparent to the person skilled in the art once given the disclosure herein. The scope of the disclosure is not limited by the described embodiments but only by the accompanying claims.

1. A computer program product comprising a computer program embodied on a non-transitory computer-readable storage medium and configured so as, when run on computer equipment of an allocating party, the computer equipment performs a computer-implemented method of generating at least one transaction associated with a blockchain, the at least one transaction being for distributing amounts of an allocation of a digital asset from the allocating party to one or more recipient parties, wherein the allocating party is associated with an allocating public key linked with the allocation, wherein each recipient party is associated with a respective ownership public key; and wherein the method comprises:
obtaining a respective ownership public key of each of the one or more recipient parties;
for each of the one or more recipient parties, generating a respective payment public key based on (i) the ownership public key associated with that recipient user, and (ii) the allocating public key; and
generating the at least one transaction, wherein the at least one transaction comprises one or more output scripts, each output script configured to transfer a respective amount of the allocation to a respective payment address, the respective payment address being based on the respective payment public key.

2. (canceled)

3. The computer program product of claim 1, wherein the allocating public key is paired with an allocating private key, and wherein the method comprises making the allocating private key available to the one or more recipient parties.

4. The computer program product of claim 1, wherein each ownership public key is associated with a respective weighting, and wherein the method comprises:
for each recipient party, obtaining the respective weighting associated with their ownership public key, wherein the respective amount of the allocation to be transferred to that recipient party is based on the obtained respective weighting.

5. The computer program product of claim 1, wherein the blockchain comprises a plurality of unspent transaction outputs, wherein each unspent transaction output is linked with a respective unspendable transaction output comprising the ownership public key of a respective recipient party, and wherein said obtaining of the respective ownership public key comprises obtaining the respective ownership public key from the unspendable transaction output linked with a respective unspent transaction output.

6. The computer program product of claim 5, wherein each unspent transaction output comprises a respective representation of a the weighting; and
said obtaining of the respective weighting comprises, for each recipient party, obtaining the respective weighting based on the respective representation in the unspent transaction output linked with the respective unspendable transaction output comprising the ownership public key of that recipient party.

7. The computer program product of claim 6, wherein each representation of the weighting is a representative amount of the digital asset.

8. The computer program product of claim 5, wherein the method further comprises:
determining whether the respective ownership public key of each of the one or more recipient parties is an active ownership public key based on whether the respective ownership public key is linked with an unspent transaction output; and
said generating of the respective payment key comprising only generating respective payment keys for active ownership public keys.

9. The computer program product of claim 1, wherein the blockchain comprises a plurality of transactions having unspendable transaction outputs, each unspendable transaction output comprising the ownership public key of a respective recipient party, and wherein said obtaining of the respective ownership public key comprises obtaining the respective ownership public key from the respective unspendable transaction output.

10. The computer program product of claim 9, wherein each unspendable transaction output comprises a representation of a weighting associated with the respective ownership public key; and
wherein said obtaining of the respective weighting comprises, for each recipient party, determining the respective weighting based on the representation in the respective unspendable transaction output.

11. The computer program product of claim 9, wherein the method further comprises identifying each unspendable transaction output based on a predetermined identifier included within the unspendable transaction output.

12. The computer program product of claim 11, wherein the method further comprises:
for each recipient user, determining whether their respective ownership public key is an active ownership public key based on whether the at least one unspendable transaction output comprising their respective ownership public key comprises the predetermined identifier; and
said generating of the respective payment key comprising only generating respective payment keys for active ownership public keys.

13. (canceled)

14. The computer program product of claim 1, wherein the at least one transaction is a single transaction, the single transaction comprising the one or more output scripts.

15. The computer program product of claim 1, wherein one or more payment addresses are escrow payment addresses, and wherein the method comprises withholding the allocating private key from at least one of the one or more recipient parties until at least one condition is fulfilled by said at least one recipient party.

16. The computer program product of claim 1, wherein the method further comprises:
generating an updated allocating public key;
for each of the one or more recipient parties, generating an updated respective payment public key based on (iii) the ownership public key associated with that recipient party, and (iv) the updated allocating public key; and
generating the at least one transaction, wherein the at least one transaction comprises one or more output scripts, each output script configured to transfer a respective amount of the allocation to a respective updated payment address of a respective recipient party, the respective updated payment address being based on the respective updated payment public key.

17. The computer program product of claim 16, wherein the method further comprises, publishing an updated allocating private key paired with the updated allocating public key.

18. The computer program product of claim 1, wherein the allocation is transferred, using a transaction of the blockchain, from an issuing public key associated with an issuing party to an allocating address based on the allocating public key.

19. The computer program product of claim 3, wherein the allocating private key is stored within a trusted execution environment, and wherein the allocating private key is only accessible by the allocating party after said causing of the at least one transaction to be included in the blockchain.

20. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a computer-implemented method of generating at least one transaction associated with a blockchain, the at least one transaction being for distributing amounts of an allocation of a digital asset from an allocating party to one or more recipient parties, wherein the allocating party is associated with an allocating public key linked with the allocation, wherein each recipient party is associated with a respective ownership public key; and wherein the method comprises:
obtaining a respective ownership public key of each of the one or more recipient parties;
for each of the one or more recipient parties, generating a respective payment public key based on (i) the ownership public key associated with that recipient user, and (ii) the allocating public key; and
generating the at least one transaction, wherein the at least one transaction comprises one or more output scripts, each output script configured to transfer a respective amount of the allocation to a respective payment address, the respective payment address being based on the respective payment public key.

21. (canceled)

22. A computer program product comprising a computer program embodied on a non-transitory computer-readable storage medium and configured so as, when run on computer equipment of an allocating party, the computer equipment performs a computer-implemented method of accessing an amount of a digital asset, the amount of the digital asset being transferred from an allocating public key of the allocating party to a payment address of a recipient party using a transaction associated with a blockchain, wherein the recipient party is associated with an ownership public key; and wherein the method comprises:
causing a first transaction comprising the ownership public key to be included in the blockchain;
obtaining an allocating private key paired with the allocating public key;
determining the payment address based on a payment public key, wherein the payment public key has been generated based on the ownership public key and the allocating public key; and
determining, using the allocating private key, a payment private key paired with the payment public key.

23-27. (canceled)

28. A computer-implemented method of generating at least one transaction associated with a blockchain, the at least one transaction being for distributing amounts of an allocation of a digital asset from an allocating party to one or more recipient parties, wherein the allocating party is associated with an allocating public key linked with the allocation, wherein each recipient party is associated with a respective ownership public key, the method comprising:
obtaining the respective ownership public key of each of the one or more recipient parties;
for each of the one or more recipient parties, generating a respective payment public key based on (i) the ownership public key associated with that recipient user, and (ii) the allocating public key; and
generating the at least one transaction, wherein the at least one transaction comprises one or more output scripts, each output script configured to transfer a respective amount of the allocation to a respective payment address, the respective payment address being based on the respective payment public key.
